(19) United States
(12) Patent Application Publication
(10) Pub. No.: US 2004/0250718 A1
(43) Pub. Date: Dec. 16, 2004

(54) Supply system for silk-screen printing machine

(76) Inventors: Giuseppe Principe, Milan (IT); Luigi Bellu, Milan (IT); Alessandro Restelli, Milan (IT)

Correspondence Address: James V. Costigan, Esq., Hedman & Costigan, P.C., Suite 2003, 1185 Avenue of the Americas, New York, NY, 10036-2646, US

(21) Appl. No.: 10/697,775

(22) Filed: Oct. 30, 2003

(30) Foreign Application Priority Data
Jun. 10, 2003 (IT) MI2003A 001162

(51) Int. Cl. B41F 21/00

(52) U.S. Cl. 101/232

(57) ABSTRACT

Supply system (10) for a silk-screen printing machine comprising a supply table (20) mobile on longitudinal guides (22) in a longitudinal advancing direction (F) of a sheet (12) able to be registered longitudinally through longitudinal registering means (60), the supply system (10) comprising transversal registering means (40) which comprise locking means (50) suitable for locking the sheet (12) on the supply table (20) for a predetermined time and an actuator (24) to move the supply table (20) in a direction transversal to the longitudinal direction (F) such as to allow the registering of the transversal position of the sheet (12) without misaligning it with respect to the longitudinal direction (F).

The present invention refers to a supply system for a silk-screen printing machine.

As is known in automatic silk-screen printing machines, the sheet is advanced manually or mechanically on a table up to a predetermined position in a pincer suitable for transporting it to a silk-screen printing plane.

The stop position of the sheet before being gripped is determined by elements in register, which from above engage the supply plane of the sheet in the pincer and which prevent the sheet from advancing beyond the desired position.

The closing of the pincers to grip the sheet is then commanded by an authorisation signal transmitted by one or more photocells aligned with the elements in register.

Current silk-screen printing machines foresee the advancing of a sheet on a table and then the longitudinal registering thereof through longitudinal registering means.

Then said sheet is registered laterally to the advancing direction of the sheet itself through a pincer system which grips the sheet and pulls it laterally against a striker. Finally, the sheet is gripped by a transportation system which sends it to the printing plane where it is silk-screen printed.

A drawback of current silk-screen printing machines is that for very large sheets the lateral registering can involve misalignment of the sheet with respect to the longitudinal advancing direction thereof compromising the possibility of obtaining a good quality end product.

Another drawback is that a complex sequence of movements is necessary to avoid hindering the members in movement.

Moreover, known silk-screen printing machines are not very flexible compared to the size of the sheets which can be supplied to the machine and above all different regulations are necessary according to the materials which must be printed: thickness, weight and surface type.

The purpose of the present invention is that of realising a supply system for a silk-screen printing machine which overcomes the previous drawbacks.

The purpose of the present invention is that of realising a supply system for a silk-screen printing machine which allows high precision supply of the sheets to be silk-screen printed to be obtained.

Another purpose is that of realising a supply system for a silk-screen printing machine which allows the registering of the sheet transversally to the advancing direction thereof.

Another purpose of the present invention is that of realising a supply system for a silk-screen printing machine which is adaptable to various materials and different sizes of sheets to be printed in a quick and simple way.

A further purpose of the present invention is that of realising a supply system for a silk-screen printing machine which is particularly simple and functional, with contained costs.

These purposes according to the present invention are accomplished by realising a supply system for a silk-screen printing machine as outlined in claim 1.

Further characteristics of the invention are highlighted by the subsequent claims.

The characteristics and the advantages of a supply system for a silk-screen printing machine according to the present invention shall become clearer from the following description, given as an example and not for limiting purposes, referring to the attached schematic drawings, in which:

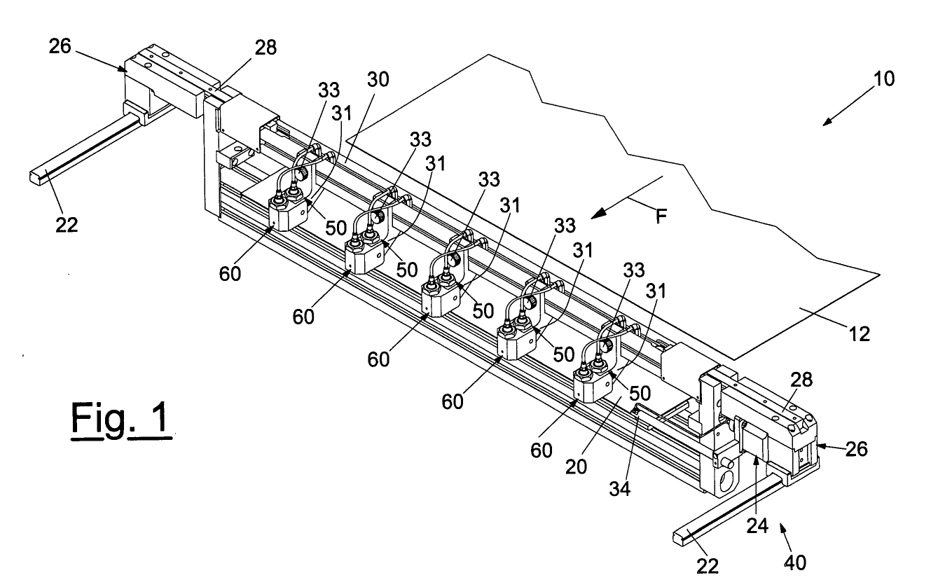

FIG. 1 is a top right front perspective view of a supply system according to the present invention;

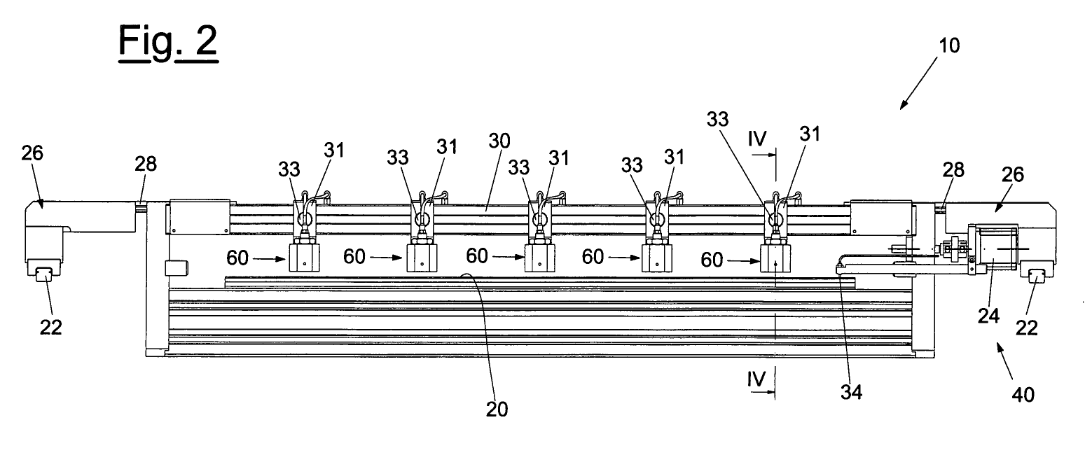

FIG. 2 is a front view of the supply system of FIG. 1;

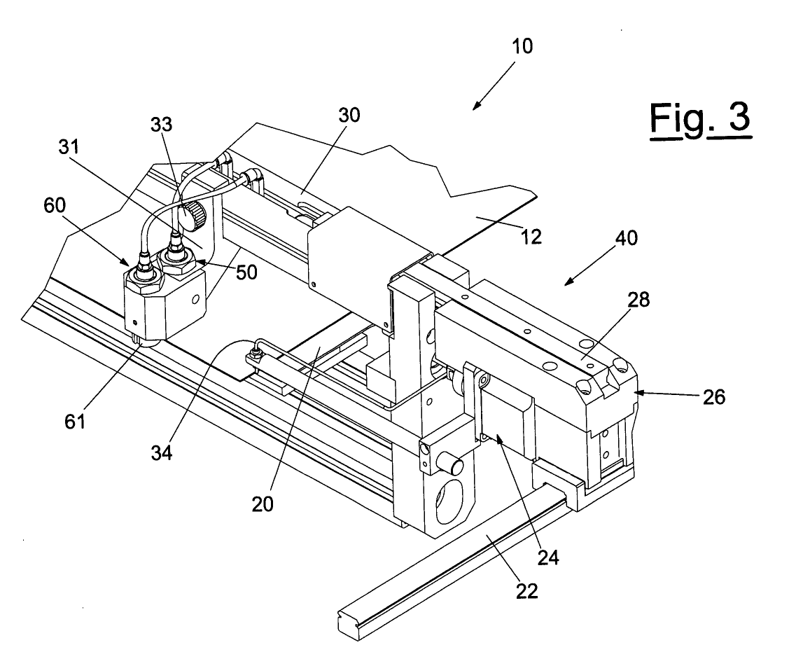

FIG. 3 is a top right front perspective view of a detail of FIG. 1;

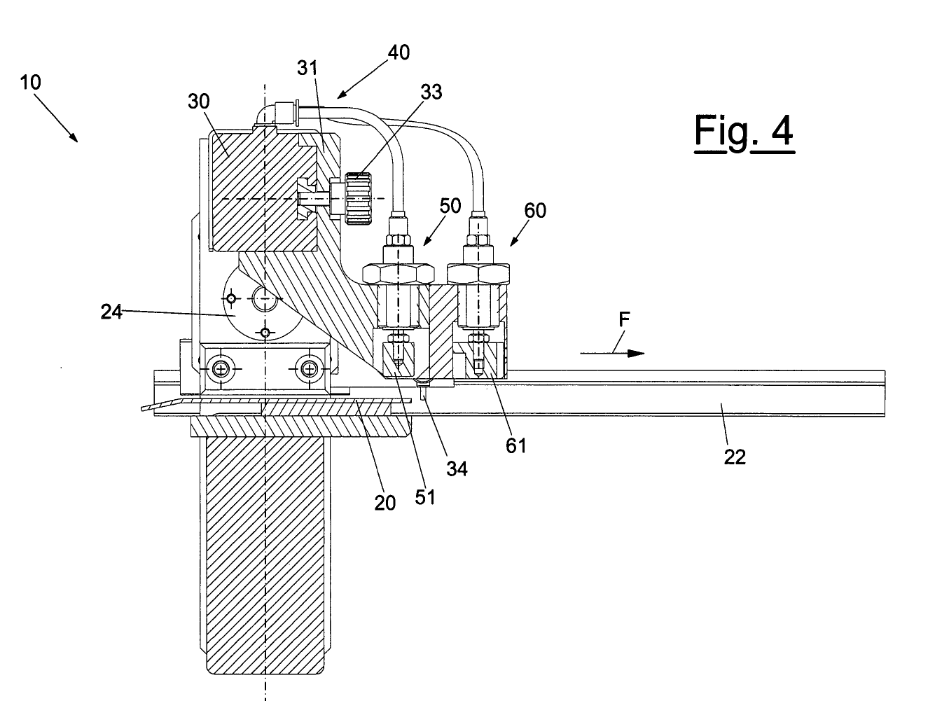

FIG. 4 is a top side view of a section IV-IV of the supply system of FIG. 2.

With reference to the figures, a supply system 10 for a silk-screen printing machine is shown, comprising a table 20 for supplying a sheet 12 to be printed capable of sliding in a longitudinal advancing direction F of the sheet 12 itself along two longitudinal guides 22 towards a printing plane not shown in the figures.

The supply system 10 comprises longitudinal registering means 60 which allow the longitudinal registering of the sheet 12 in the longitudinal direction F, and transversal registering means 40 for the transversal registering of the sheet 12 in a direction perpendicular to the longitudinal direction F.

The transversal registering means 40 comprise locking means 50 suitable for locking the sheet 12 on the supply table 20 for a predetermined time and an actuator 24 to move the supply table 20 in a direction perpendicular to the advancing direction of the sheet 12 such as to allow the registering of the transversal position of the sheet 12 without misaligning it with respect to the longitudinal advancing direction F of the sheet 12 itself.

This is possible since the transversal registering means 40 comprise two transversal guides 28 which couple with the supply table 20 allowing it to slide in the transversal direction to the longitudinal direction F.

Each of said transversal guides 28 is respectively housed in a support shoulder 26, each of which in turn is respectively coupled with a longitudinal guide 22 and is able to slide with respect to it.

Each support shoulder 26 has an upright and a shoulder. The upright has a link-block shaped end portion which respectively engages with a longitudinal guide 22 to allow the sliding in the longitudinal direction F, whereas the shoulder has a groove which respectively couples with a longitudinal guide 28 to allow sliding in the transversal direction, thus giving the table 20 the possibility of moving in two directions-longitudinal F and transversal.

The supply system 10 also comprises an optical sensor 34, suitable for detecting the presence of the sheet 12, and an actuator 24 capable of moving the table 20 transversally.

The optical sensor 34 and the actuator 24 are both fixed to one of the two support shoulders 26.

The optical sensor 34 can be situated both above the sheet 12 and in the part below it in a suitable hollow.

The transversal registering means 40 comprise a support shaft 30 suitable for supporting the locking means (50) and fixed to the table (20) for supplying the sheet (12), which carries a plurality of supports 31 aligned along it, each of which is fixed to the shaft 30 respectively through an attachment screw 33.

In this way it is possible to vary their position along said shaft 30 to be able to adapt the supply system 10 to the different printing formats of the sheets in a quick and simple manner.

The locking means 50 comprise a plurality of pressure elements 51 which can be activated through pressurised air, each of which is respectively housed in one of the supports 31.

The longitudinal registering means 60 comprise a plurality of retractable stop elements 61 of the sheet 12, capable of cooperating with the optical sensor 34 to register the longitudinal position of the sheet 12.

Each of the retractable stop elements 61 is also housed in the respective support 31 of the shaft 30 and, when activated, prevents the advance of the sheet 12 beyond an easily predetermined longitudinal position.

The sheet 12 is initially made to advance on the supply table 20 in the supply direction F, until it is detected by the optical sensor 34. The sheet 12 is then longitudinally registered through the longitudinal registering means 60.

Then the locking means 50 are activated which, activating the pressure elements 51, lock the sheet 12 on the supply table 20.

This allows the transversal registering of the sheet 12 through the transversal registering means 40 since the actuator 24, cooperating with the optical sensor 34, moves the table 20 and thus also the sheet 12 fixed to it until a predetermined transversal position is reached, also keeping the axis of the sheet 12 constantly aligned with the longitudinal direction F.

Finally, keeping the sheet 12 still on the supply table 20, it is made to advance in the longitudinal advancing direction F towards the printing plane where it will be silk-screen printed.

It has thus been seen that a supply system for a silk-screen printing machine according to the present invention realises the purposes outlined previously.

The supply system for a silk-screen printing machine of the present invention thus conceived is susceptible to numerous modifications and variants, all covered by the same inventive concept.

Moreover, in practice the materials used, as well as their size and components, can be whatever according to the technical requirements.

1. Supply system (10) for a silk-screen printing machine comprising a supply table (20) which moves on longitudinal guides (22) in a longitudinal advancing direction (F) of a sheet (12), said sheet (12) being able to be registered longitudinally by being passed under longitudinal registering means (60), said supply system (10) comprising transverse registering means (40) which comprise locking means (50) suitable for locking the sheet (12) on the supply table (20) for a predetermined time and an actuator (24) to move the supply table (20) in a direction perpendicular to the longitudinal direction (F) so as to allow the registering of the transverse position of the sheet (12) without misaligning it with respect to the longitudinal direction (F) wherein the transverse registering means (40) comprises a support shaft (30) suitable for supporting the locking means (50) and fixed to the supply table (20) which carries a plurality of supports (31) aligned along it, each of which is fixed to the shaft (30) respectively through an attachment screw (33).

2. Supply system (10) for a silk-screen printing machine according to claim 1, wherein the transverse registering means (40) comprise two transversal guides (28) which couple with each other and are able to slide along the longitudinal guides (22), said supply table (20) being coupled with said transverse guides (28) and being slidable in a direction transverse to the advancing direction of the sheet (12).

3. Supply system (10) for a silk-screen printing machine according to claim 2, wherein the transverse registering means (40) comprise two support shoulders (26) which couple with each other and are able to slide with respect to two longitudinal guides (22), and in which the two transverse guides (28) are respectively housed.

4. Supply system (10) for a silk-screen printing machine according to claim 3, wherein the transverse registering means (40) comprise an optical sensor (40).

5. (canceled

6. Supply system (10) for a silk-screen printing machine according to claim 1 wherein the locking means (50) comprise a plurality of pressure elements (51) which can be activated through pressurized air, each of which is respectively housed in one of the supports (31).

7. Supply system (10) for a silk-screen printing machine according to claim 1, wherein the longitudinal registering means (60) comprise retractable stop elements (61) capable of cooperating with the optical sensor (34) to register the longitudinal position of the sheet (12).
